(19) United States
(12) Patent Application Publication
(10) Pub. No.: US 2014/0149158 A1
(43) Pub. Date: May 29, 2014

(54) RETAIL MATH OPTIMIZATION

(71) Applicants: Jens Odenheimer, Karlsruhe (DE); Peter Eberlein, Malsch (DE)

(72) Inventors: Jens Odenheimer, Karlsruhe (DE); Peter Eberlein, Malsch (DE)

(21) Appl. No.: 13/687,329

(22) Filed: Nov. 28, 2012

(51) Int. Cl. G06Q 10/06

(52) U.S. Cl. CPC G06Q 10/063
USPC 705/7.11

(57) ABSTRACT

A system and method for retail math optimization that receives a selection of a product display type, receives selection of a product display configuration template, the product configuration template specifying a product and a quantity of the product, determines a revenue per square foot for a retail space based on the product display type and the product display configuration template, and displays the revenue per square foot.

### BACKGROUND

The present disclosure generally relates to methods and systems for utilizing retail space, and more particularly, to mobile electronic applications that enable a user to calculate and maximize the profitability of a store.

The use of retail floor space is critical for retailers seeking to maximize profits. As retailers struggle with product placement decisions, they are also inundated with requests from sales representatives seeking better placement for the products they sell to retailers. In light of the increasing cost of retail space and the ever increasing number of products, the challenges posed to retailers will become increasingly difficult. This is especially true in urban areas where the cost of retail space can be very high.

To assist with product placement decisions, retailers often turn to industry knowledge and their own experience to manage floor space. One approach that is often taken is to group products by category (e.g., cleaners, vegetables, frozen foods, electronics, household appliances, etc.). In addition, retailers often rely upon profit per square foot as a key figure to measure profitability of a store.

As both retailers and sales representatives are aware, many consumer purchasing decisions are made at the point-of-sale. Although some consumers remain loyal to certain products, many consumers are often willing to change brands. In addition, the products that customers ultimately choose can be influenced by product displays and product placement. For example, a product located on an upper or lower shelf is unlikely to sell as well as a product placed at eyelevel. Aware of these consumer behaviors, retailers and sales representatives are also aware that inefficient use of retail space directly results in reduced revenues.

Many organizations use business intelligence systems to analyze business data and provide additional quantitative information that can be used in decision making. For example, businesses may use an intelligence system to forecast future sales of a product based on an analysis of past sales data. Unfortunately, these systems often do not account for product placement data.

Accordingly, the embodiments of the present disclosure promote the use of product displays that achieve optimal use of retail space.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure. In the drawings:

FIG. 1 illustrates a method for mobile retail math optimization according to an example embodiment of the present disclosure;

FIG. 2 illustrates a system level architecture that depicts the interaction between a remote electronic device and a backend system according to an example embodiment of the present disclosure;

FIG. 3 illustrates a representative view of a portable electronic device having a retail math application according to an example embodiment of the present disclosure; and

FIG. 4 illustrates a method for displaying a retail space according to an example embodiment of the present disclosure; and

FIG. 5 illustrates a representative architecture of a portable electronic device according to an example embodiment of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using a device are described. In some embodiments, the device is a portable communication device (e.g., a mobile phone or tablet). The user interface may include a touch screen and/or other input/output devices. In the discussion that follows, a portable communications device is used as an example embodiment. It should be understood, however, that the user interfaces and associated methods may be applied to other devices, such as personal computers and laptops, that may include one or more other physical user-interface devices, such as a keyboard and or mouse.

The portable communication device may support a variety of applications, such as telephone, text messenger, and retail applications. The various applications that may be executed on the device may use at least one common physical user-interface device, such as a touch screen. One or more functions of the touch screen as well as corresponding information displayed on the device may be adjusted and/or varied from one application to another and/or within a respective application. In this way, a common physical architecture of the device may support a variety of applications with user interfaces that are intuitive and transparent. In the discussion that follows, a retail space application is used as an example embodiment, but it should be understood that the user interfaces and associated methods may be applied to other applications.

Embodiments of the present disclosure are directed to methods and systems for optimizing the use of retail floor space. The described methods and systems utilize several types of information that includes, but is not limited to, standard and customized product displays, product placement, number of items displayed, product turnover rates, product dimensions, profit per product sold, product sales trend, price, etc. Retailers and sales representatives can utilize the mobile retail application to access local and remotely stored information. A retail math calculation engine analyzes these data to provide profit per square foot data for one or more product displays in real-time.

A retail space application that allows the user to customize one or more product displays (e.g., modify the items or change the entire rack) is provided. When the product display is changed, the retail space application calculates an estimated profit per square foot based on data provided by a business backend system. For example, the user of the retail space application may be a sales representative trying to persuade a store owner to purchase a certain display for certain products. Alternatively, the user may also be a store owner trying to maximize the profitability of the store. Using a mobile device such as a tablet, the retail space application can illustrate the location of a product display and simultaneously provide real-time retail math analysis.

A user viewing a retail display may vary the display and its contents. Using a user-interface of the portable communication device, a user may change the product displays and compare the calculated profitability for each alternative display. In the case of a touch screen, the product display may be changed by dragging the displays illustrated on the touch screen.

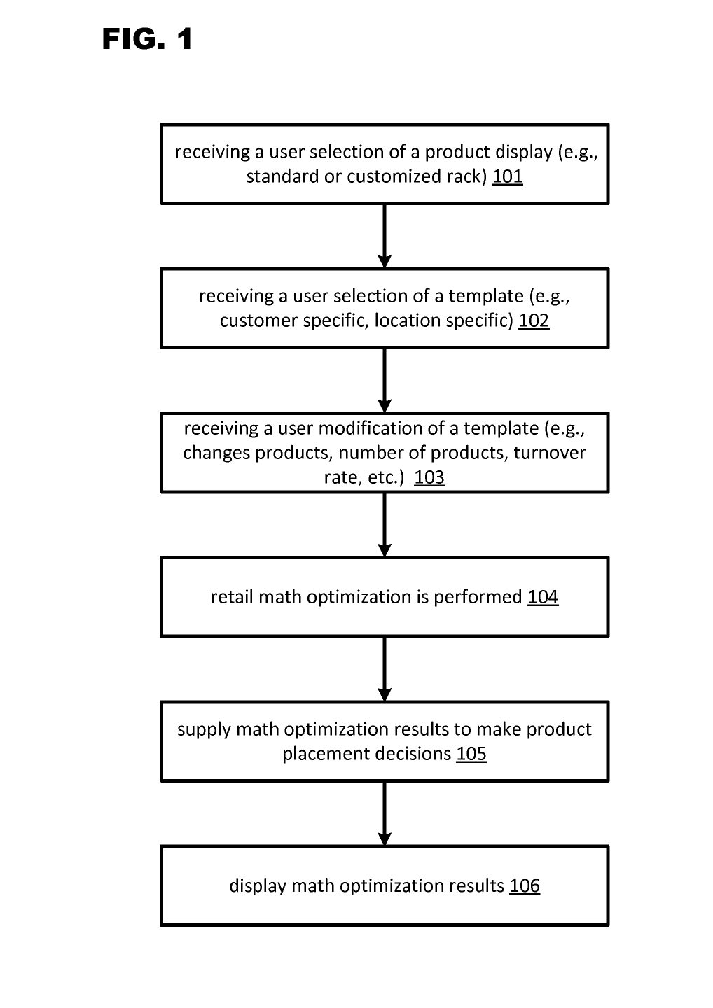

FIG. 1 illustrates a method for mobile retail math optimization according to an example embodiment of the present disclosure.

At step 101, a backend system, such as a server, receives a user selection of a product display. Several types of product displays are possible, and can be selected to accommodate different placements within the retail floor space. Some examples of type of product displays include full size showcases, gridwall or slackwall panels, standing, or countertop lazy Susans, etc. In addition, the product display may be a standard rack, or a rack that was created or defined by the user.

A product display may be dedicated to a single product or brand of products, but can also be designed to include a variety of products and brands. For example, in high-end fashion or apparel retail, brands typically have their own racks to promote brand recognition. Alternatively, some items, such as sunglasses or cellular phones, have several types of accessories (e.g., cases, cleaners, chargers, etc.) produced by different manufacturers, but still displayed on the same rack.

The retail math application may also include a rack preferences menu that enables a user to define a customized display. Of the numerous possible product displays, some examples include product specific displays and mixed products displays. Customized product displays may be more applicable for certain types of products. For example, a retailer of sunglasses may use several customized product displays, one for each brand. Alternatively, the retail math application may also provide one or more pre-defined product displays that may also be applied by a user.

The retail math application may display a visual representation of a default retail floor space. For example, the default retail space may be generic based on the type of retail store being modeled (e.g., department, convenient, clothing, etc.), or may be specifically modeled on the retail store of a specific retailer. Within the default retail space, the user may add one or more product displays. Product displays may be added, deleted, or modified in accordance with selections from the user.

At step 102, the backend system receives a user selection of a template. A template is a product display configuration indicating attributes of the display that can indicate a product type, number of products displayed, as well as the arrangement of items within a product display. For example, a certain number of pegs or shelves may be included in a template. In another example, a predefined variety of products may be included in a template. Templates may be a customer, location, store, or even rack specific template.

Once the product display and template are selected, the position of the resulting product display can be visualized within the visual representation of the retail floor space. To assist a retailer or sales representative in product display and placement decisions, additional data can be superimposed on the product display and retail floor space. For example, product display data, such as the number of items per peg, turnover rate, price, and the like can be displayed. In addition, key figures, such as the profit margin per square foot, can also be displayed.

Next, at step 103, the backend system receives a user modification of a template. In other words, when a user, at a remote electronic device, navigates the retail math application and modifies a template, the backend system receives and stores changes made. By modifying the template, an update to the data provided by the backend system to the retail display may be triggered. Typically, a user opens the retail math application to view and/or modify (add, delete, change, etc.) one or more product displays of the retail floor space. For example, the user may change one or more variables including the product, number of products displayed, turnover rate, etc. In the case of a touch screen, the template shown may be changed by dragging a template across the screen into a product display. As the user changes templates, the calculated profit per square foot as well as other data also displayed to the user may also be updated.

The step of setting one or more customized product displays may be performed initially when installing or first using the retail math application. Afterwards, a user may add, delete, or modify the customized product displays as desired.

As discussed above, the retail math application illustrates a retail space and product display superimposed data. As a user changes the product display and placement, the retail math application simultaneously updates the illustrated data to account for the changes made by the user. Of particular interest to both the retailer and sales representative would be the updated profit per square foot.

At step 104, the backend system receives a request, from the remote electronic device, to perform retail math optimization. The request includes, for example, a message indicated that retail math optimization should be performed based on a user selected product display and template, and product placement.

Upon receipt of the request, the backend system can calculate the profit per square foot for a particular product display placement, at step 105. The backend system supplies the result to the remote electronic device so that a user can make product placement decisions. Generally, if the resulting profit per square foot meets or exceeds the retailer's desired threshold, then the product sales representative will be more likely to persuade the retailer to use or purchase the specified product display. Thus, a retail math application that allows a user to accurately predict a store's profitability is provided.

Example uses of the retail math optimization will now be provided. In this example, a store owner is deciding between a large rack displaying few expensive products having a high profit per item and moderate turnover rate, or a small rack displaying inexpensive goods having a lower profit per item and a high turnover rate.

In the first option, the large rack may have 4 sides with 8 pegs each, each peg holding three items. The large rack may be provided at zero cost by an item manufacturer. Also, the large display may require 8 square feet of floor space. In this example, each item may cost the store owner $46 but have a retail price of $200. With a turnover rate of 8 items per day, the resulting profit margin for the large display would be $154 per square foot.

Now we can turn to the second, smaller display, option. In the second option, the small display is a countertop display requiring one square foot of floor space. The small display may have 2 sides with 20 pegs each, each peg holding five items. In the second option, the display would be sold to the store owner by an item manufacturer for $150. In this example, each item may cost the store owner $5 but have a retail price of $10. With a turnover rate of 50 items per day, the resulting profit margin for the large display would be $227 per square foot.

Comparing the large and small display options above, the shop owner would likely select the small display despite having to purchase a rack. Its should be appreciated that by changing the product display placement, the expected turnover rate stored in the backend system may also change. As a consequence, the calculated profit margins would also vary, and potentially change the shop owner's selection decision.

The method depicted in FIG. 1 generally occurs at the time the product sales representative visits the retailer. Beforehand, the sales representative may identify the retailer's account and geographic location in order to provide information catered to a specific retailer. Alternatively, the method may be applied directly by retailers.

In some embodiments, the retail math application may prompt a user for a login name and login password. The login name and login password may then be used to identify individual users associated with the business backend system.

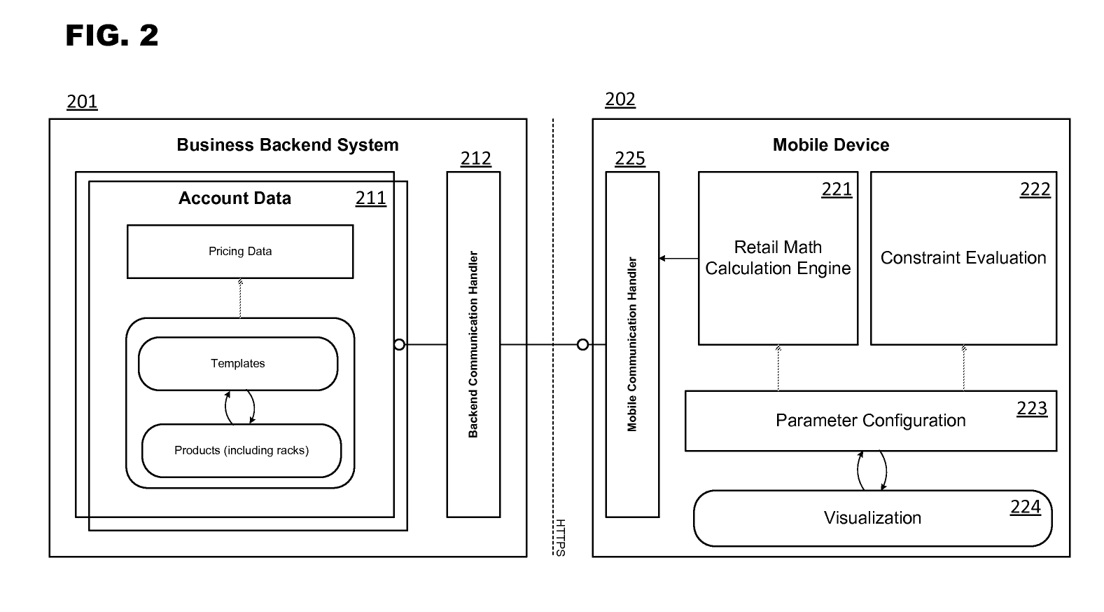

FIG. 2 illustrates a system level architecture that depicts the interaction between a remote electronic device and a backend system according to an example embodiment of the present disclosure.

As shown in FIG. 2, the system level architecture includes a business backend system 201 (e.g., SAP Business ByDesign) that is connected to a portable electronic device 202. The business backend system 201 can be connected to portable electronic device 202 using known or expected network technologies, such as wireless local area networks (WLAN) or wireless wide area networks (WWAN), some examples of which include WiFi, long term evolution (LTE), and the like. Backend communication handler 212 and mobile communication handler 225 manage communications functions for the business backend system 201 and mobile device 202, respectively.

Business backend system 201 includes one or more account database 211 that store several types of information that can be queried by the mobile device 202. For example, account database 211 stores standard and customized product displays, templates, product placement sales data, product turnover rates, product dimensions, profit per product sold, product sales trend, prices, etc. The data can be industry, geographic, or customer specific. Sales representatives and retailers may acquire rights to access different levels of information.

Within the mobile device, parameter configuration module 223 can also store product displays and templates. In addition, the parameter configuration module 223 also enables the user to modify and customize product displays and templates. For example, the type of product displayed and product placement can be adjusted through the parameter configuration module 223. In addition, the number of items per peg can also be varied. A constraint evaluation module 222 verifies that the user's proposed product display is feasible. For example, if a user wants to put 20 large items (3 inches deep) on a peg that only holds 5 (peg length=15 inches), the constraint evaluation may automatically adjust the quantity to the maximum possible or provide an error message to the user.

If the constraints are satisfied, the retail math calculation engine 221 calculates the profit per square foot based on information provided by the account database 211 of business backend system 201.

Visualization module 224 manages the display functions of the retail math application. As described above, the retail math application illustrates a retail floor space as well as product displays and corresponding data. When a user modifies a product display, template, or display placement, the retail math application also updates the illustrated data to account for the changes made by the user.

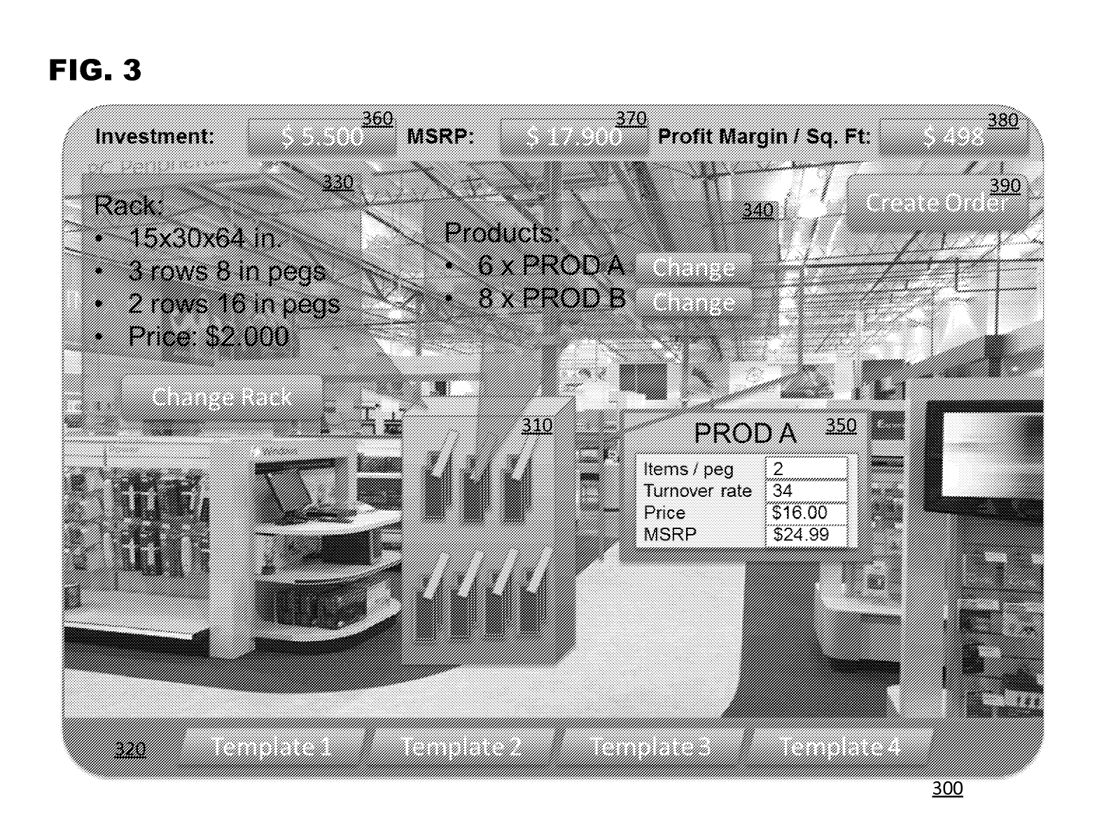

FIG. 3 illustrates a representative view of a portable electronic device having a retail math application according to an example embodiment of the present disclosure. The representative view 300 includes an example product display 310 and a plurality of templates 320 that may be applied to product display 310. In addition, a plurality of information displays 330-380 relating to product display 310 are provided. Some examples of information displays included a rack description, number and type of product displayed, items per peg, turnover rates, unit cost, sales price, and profit per square foot. Lastly, there is a create order button 390 that enables a sales representative or retailer to stock the items depicted by the proposed product provided that the profit per square foot exceeds the retailer's threshold.

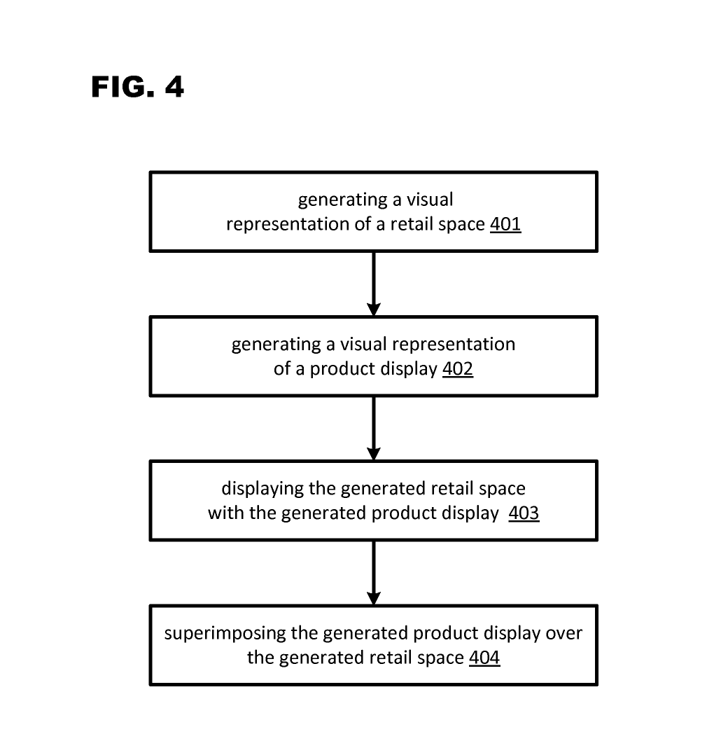

FIG. 4 illustrates a method for displaying a retail space according to an example embodiment of the present disclosure.

At step 401, one or more visualization modules of the portable electronic device generate a visual representation of a retail store. At the outset, the retail math application can display a generic retail floor space corresponding to the type of retail store being modeled. Alternatively, the retail math application can display a floor space based on the retail store of a specific retailer. Visualizations of retail space may be stored at the portable electronic device, or may be stored and supplied by the backend system.

Next, at step 402, one or more visualization modules of the portable electronic device generate a visual representation of a product display. The visualized product display may be depicted alone or with its associated products. Once a user selects to add one or more product displays, a menu of product display types and/or product displays can be provided. The variety of product displays can be stored at the portable electronic device, or may be supplied by the backend system. As discussed above, the product display and its contents can be changed in response to a user selection.

At step 403, the portable electronic device displays the visual representation of the retail space along with the visual representation of the product display. For example, a menu of product display types and/or product displays can be provided adjacent to the visual representation of the retail space. In another example, the retail math application, at step 404, superimposes the visual representation of the product display over the visual representation of the retail space, as illustrated in FIG. 3. Once the product display is superimposed on the retail space, the product display may be moved to various locations within the retail space. In the case of a touch screen interface, a user may simply drag the product display to its desired location.

In some instances, the backend system or the portable electronic device may supply product display attributes at the request of the user. Upon selection of a particular display, attributes, such as, dimensions of the product display, capacity of the product display, price of the product display, an image of the product display, a number of shelves, a number of rows, a number of rows having a number of pegs, and a list of product display configuration templates associated with the product display can be displayed. When the backend system or the portable electronic device supplies product display attributes, the attributes can be displayed to the user.

In a similar manner, the backend system or the portable electronic device may also supply product information, such as price, manufacturer suggested retail price, turnover rate, an image for the product, a quantity of the product, a quantity for each product display type indicating a number of products that can be displayed per portion of a product display having the product display type, and a quantity of the product that can be displayed per peg. When the backend system or the portable electronic device supplies product information, the product information can be displayed to the user.

In instances when multiple product displays are selected, the profit per square foot calculation for the retail space can be based on the location of each of the multiple product displays. In addition, the calculated profit per square foot can also be based on the distance between the product displays.

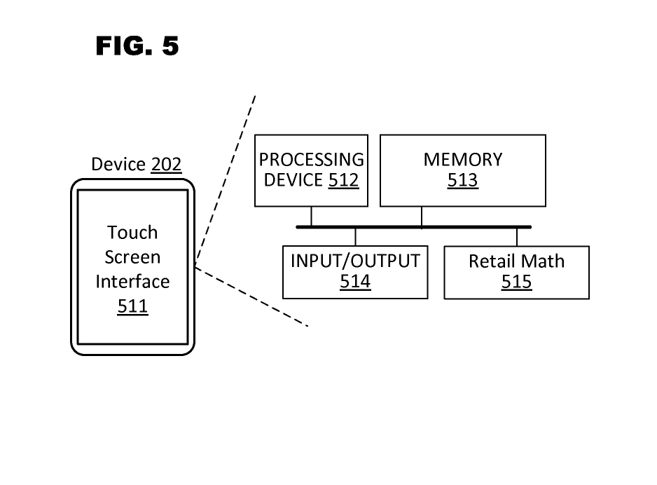

FIG. 5 illustrates a representative architecture of a portable electronic device according to an example embodiment of the present disclosure.

A portable electronic device 202 may include a touch screen interface 511, processing device 512, memory 513, and input/output module 514. The touch screen interface 511 may include a display, which may be a touch screen, capable of displaying data to a user of the portable electronic device 202. Portable electronic device 202 may also include a retail math application module 515 that generally implements the functionality of the retail math application. The components of the retail math module 515 are explained in detail with reference to FIG. 2.

Although not shown, the touch screen may include a sensor that may be a capacitive touch detection sensor, configured to detect and track movement on the surface and/or in the vicinity of the display. The sensor may be coupled to a signal processing circuit that is configured to identify, locate, and/or track object movement based on the data obtained from sensor.

Memory 513 may include a computer readable medium storing application modules, which may include instructions associated with applications and modules of the portable electronic device 202.

The input/output module 514 manages the functionality of touch screen interfaced 511. For example, input/output module 514 may include functionality for identifying a touched first point within the retail math application displaying a product display. An alternate product display may be selected by dragging the alternate product display onto the existing product display. In another example, different templates may be selected by pressing template buttons displayed by the retail math application on touch screen 511.

The portable electronic device may contain a processing device 512, memory 513, and a communications device 225 (as shown in FIG. 2), all of which may be interconnected via a system bus. In various embodiments, the device 202 may have an architecture with modular hardware and/or software systems that include additional and/or different systems communicating through one or more networks via communications device 225.

Communications device 225 may enable connectivity between the processing devices 512 in the device 202 and other systems by encoding data to be sent from the processing device 512 to another system over a network and decoding data received from another system over the network for the processing device 512.

In an embodiment, memory 513 may contain different components for retrieving, presenting, changing, and saving data and may include computer readable media. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system. Memory 513 may be capable of storing user inputs and preferences as well as customized displays and templates. In some instances, a cache in memory 513 may store calculated changes to the profit per square foot based on modifications to product displays.

Processing device 512 may perform computation and control functions of a system and comprises a suitable central processing unit (CPU). Processing device 512 may include a single integrated circuit, such as a microprocessing device, or may include any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the disclosure to the precise forms disclosed. For example, although the processing device 512 is shown as separate from the modules 514 and 515 and the touch screen interface 511, in some instances the processing device 512 and the touch screen interface 511 and/or one or more of the modules 514 and 515 may be functionally integrated to perform their respective functions.

It will be apparent to those skilled in the art that various modifications and variations can be made in the method and system for mobile retail math optimization of the present disclosure without departing from the spirit or scope of the disclosure. Thus, it is intended that the present disclosure cover the modifications and variations of this disclosure provided they come within the scope of the appended claims and their equivalents.

We claim:

1. A method, the method comprising:
receiving selection of a product display type;
receiving selection of a product display configuration template, the product configuration template specifying a product and a quantity of the product;
determining a revenue per square foot for a retail space based on the product display type and the product display configuration template; and
displaying the revenue per square foot.

2. The method of claim 1, further comprising:
receiving a modification to the product display configuration template; and
determining an updated revenue per square foot for the retail space based on the product display type and the modified product display configuration template; and
displaying the updated revenue per square foot.

3. The method of claim 2, wherein the product display configuration template is modified to specify a different product.

4. The method of claim 2, wherein the product display configuration template is modified to change the quantity of the product.

5. The method of claim 1, further comprising retrieving attributes for a product display having the product display type, the attributes for the product display including at least one of dimensions of the product display, capacity of the product display, price of the product display, an image of the product display, a number of shelves, a number of rows, a number of rows having a number of pegs, and a list of product display configuration templates associated with the product display.

6. The method of claim 1, further comprising retrieving information for the product, the information for the product including at least one of a price of the product, an image for the product, a manufacturer suggested retail price of the product, a turnover rate for the product, a quantity of the product, a quantity for each product display type indicating a number of products that can be displayed per portion of a product display having the product display type, and a quantity of the product that can be displayed per peg.

7. The method of claim 1, further comprising:
generating a visual representation of the retail space;
generating a visual representation of a product display having the product display type and populated with the product; and
displaying the visual representation of the retail space with the visual representation of the product display.

8. The method of claim 1, wherein the visual representation of the product display is superimposed over the visual representation of the retail space.

9. The method of claim 1, further comprising determining a location of a product display having the product display type within the retail space and determining the revenue per square foot for the retail space based in part on the location of the product display.

10. The method of claim 1, further comprising:
determining a location of a product display having the product display type within the retail space;
determining a location of a second product display within the retail space determining a revenue per square foot for the retail space based on the location of the product display and the location of the second product display.

11. The method of claim 10, wherein the revenue per square foot is determined in part based on the distance between the location of the product display and the location of the second product display.

12. The method of claim 5, further comprising displaying attributes for the product display.

13. The method of claim 6, further comprising displaying information for the product.

14. A non-transitory computer readable storage medium storing one or more programs configured to be executed by a processor, the one or more programs comprising instructions for:
receiving selection of a product display type;
receiving selection of a product display configuration template, the product configuration template specifying a product and a quantity of the product to display;
determining a revenue per square foot for a retail space based on the product display type and the product display configuration template; and
displaying the revenue per square foot.

15. The computer readable storage medium of claim 14, further comprising:
receiving a modification to the product display configuration template; and
determining an updated revenue per square foot for the retail space based on the product display type and the modified product display configuration template; and
displaying the updated revenue per square foot.

16. The computer readable storage medium of claim 15, wherein the product display configuration template is modified to specify a different product.

17. The computer readable storage medium of claim 15, wherein the product display configuration template is modified to change the quantity of the product.

18. The computer readable storage medium of claim 14, further comprising:
generating a visual representation of the retail space;
generating a visual representation of a product display having the product display type and populated with the product; and
displaying the visual representation of the retail space with the visual representation of the product display.

19. The computer readable storage medium of claim 14, further comprising determining a location of a product display having the product display type within the retail space and determining the revenue per square foot for the retail space based in part on the location of the product display.

20. A portable electronic device comprising:
one or more process; and
memory storing one or more programs for execution by the one or more process, the one or more programs including instructions for:
receiving selection of a product display type;
receiving selection of a product display configuration template, the product configuration template specifying a product and a quantity of the product to display;
determining a revenue per square foot for a retail space based on the product display type and the product display configuration template; and
displaying the revenue per square foot.
